(19) United States
(12) Patent Application Publication
(10) Pub. No.: US 2024/0346490 A1
(43) Pub. Date: Oct. 17, 2024

(54) CRYPTOCURRENCY MINING SYSTEM USING SOLAR PANEL

(71) Applicant: GA RAM PARK, Seoul (KR)

(72) Inventor: GA RAM PARK, SEOUL (KR)

(21) Appl. No.: 18/558,580

(22) PCT Filed: Dec. 28, 2022
(86) PCT No.: PCT/KR2022/021482

§ 371 Date: Nov. 2, 2023

(30) Foreign Application Priority Data
Dec. 29, 2021 (KR) 10-2021-0191184
Dec. 28, 2022 (KR) 10-2022-0186767

(51) Int. Cl. G06Q 20/36

(52) U.S. Cl. CPC G06Q 20/3678

(57) ABSTRACT

Disclosed herein is a cryptocurrency mining system using a solar panel, the system including a solar panel configured to generate electric power using sunlight, a battery configured to store the electric power generated by the solar panel, an inverter connected to the generator or the battery to convert direct current power into alternating current power, a mining device configured to mine cryptocurrency using the converted power output from the inverter, and a control device configured to monitor a mining status of the mining device.

### TECHNICAL FIELD

The present disclosure relates to a cryptocurrency mining system, and more particularly, to a system for mining cryptocurrency using electric power generated by solar panels installed in a house.

### BACKGROUND ART

Cryptocurrency (or crypto money) refers to digital currency or electronic money that is used in electronic form in a networked virtual space without having a physical object such as bills or coin.

As used herein, cryptocurrencies are sometimes referred to as virtual currencies, but will be collectively referred to herein as cryptocurrencies.

These cryptocurrencies are virtual currencies that are not tangible, as opposed to physical currencies (coins, bills) that are actually transacted. There are many types of cryptocurrencies, most notably Bitcoin, which was first developed in 2008, and other cryptocurrencies that are more actively transacted include Ripple, Ethereum, and Dogecoin. Cryptocurrencies other than Bitcoin are sometimes referred to as altcoins.

While credit cards and other convenient payments actually involve cash transactions by debiting and transferring money from bank accounts, cryptocurrencies allow people to buy and sell things without cash.

Cryptocurrencies are not issued and managed by a centralized authority, but rather have a structure where transactions are carried out by a distributed database based on peer-to-peer (P2P).

The cryptocurrency Bitcoin automatically generates a certain amount of Bitcoin at regular intervals according to a set algorithm, and ownership of the generated cryptocurrency can be transferred by solving complex mathematical and cryptographic problems created through a specific algorithm.

In solving complex mathematical and cryptographic problems created by these specific algorithms, the computational power of GPUs installed in graphics cards is superior to that of CPUs installed in the main board of computers. Accordingly, the task of mining cryptocurrency is performed by a number of hashboards equipped with graphics cards or dedicated ASICs that perform only the computations necessary for mining cryptocurrency.

In general, cryptocurrency mining is usually carried out in architectural structures called mining sites. Thus, relying on commercial electricity supplied externally for the large amount of electricity consumed by cryptocurrency mining systems during mining operations not only has the problem of high electricity bills, but also contradicts the eco-friendly energy policy aimed at reducing the use of fossil fuels. Therefore, there is a real need for solutions to address these issues.

### DISCLOSURE

### Technical Problem

Therefore, it is an object of the present disclosure to provide a cryptocurrency mining system using a solar panel that can mine cryptocurrency using the electric power generated by the solar panel and monitor the mining status in real time.

### Technical Solution

In accordance with one aspect of the present disclosure, provided is a cryptocurrency mining system using a solar panel, the system including a solar panel configured to generate electric power using sunlight, a battery configured to store the electric power generated by the solar panel, an inverter connected to a generator or the battery to convert direct current power into alternating current power, a mining device configured to mine cryptocurrency using the converted power output from the inverter, and a control device configured to monitor a mining status of the mining device.

According to one embodiment, the system may further include a central server configured to receive the cryptocurrency mined by the mining device and store the same in an electronic wallet of a house resident.

According to one embodiment, the control device may be communicably connected to the central server to monitor a status of the electronic wallet of the house resident.

According to one embodiment, the control device may perform a user authentication procedure with the house resident, wherein the mining device may mine the cryptocurrency when the user authentication procedure of the control device is successful.

According to one embodiment, based on a user input, the control device may make a request for currency exchange to the central server or a request for a payment of a predetermined transaction using the mined cryptocurrency to the central server.

According to one embodiment, the central server may control the mining device, wherein, when the mining operation is stopped due to an abnormality of the mining device, the central server may count a duration of the stopping and compensate the house resident for the stop time.

According to one embodiment, the central server may provide a portion of the mined cryptocurrency, cash exchanged for the mined cryptocurrency, or fees incurred in converting the mined cryptocurrency into another currency to the house resident, and provide the remaining portion to an operator of the central server.

According to one embodiment, the control device may be configured to determine whether power is supplied to the inverter from the battery, and turn on the mining device when the power supplied to the inverter is maintained for a first time.

According to one embodiment, when an amount of residual power stored in the battery is enough to allow the mining device to operate for at least a second time, the control device may turn on the mining device, wherein the second time may be a boot time and a shutdown time of the mining device.

According to one embodiment, upon interruption of power generation from the solar panel, the inverter may transmit a signal to turn off the mining device, wherein the battery may supply the stored residual power to the mining device to allow the mining device to operate during the shutdown time.

According to one embodiment, the system may further include a cryptocurrency mining system for a vehicle, including a vehicle mining device configured to mine cryptocurrency using the power generated by the solar panel and power generated by driving an engine of the vehicle.

According to one embodiment, the system may further include a cryptocurrency mining system for a treadmill configured to mine cryptocurrency using the power generated by the solar panel and power generated by a track of the treadmill rotated by a user walking or running.

### Advantageous Effects

A cryptocurrency mining system using a solar panel according to the present disclosure may mine cryptocurrency using the electric power generated by the solar panel and monitor the mining status in real time.

In addition, as mining is performed only when authentication is successful through a user authentication procedure, cryptocurrency acquired by mining may be prevented from being misdirected to a wrong person.

### DESCRIPTION OF DRAWINGS

FIG. 1 is a block diagram of a cryptocurrency mining system using a solar panel according to one embodiment of the present disclosure.

FIG. 2 is a step-by-step flowchart of a control method for a control device of a cryptocurrency mining system using a solar panel according to one embodiment of the present disclosure.

FIG. 3 is a step-by-step flowchart of a control method for a control device of a cryptocurrency mining system using a solar panel according to another embodiment of the present disclosure.

FIG. 4 is a step-by-step flowchart of a control method for an inverter of a cryptocurrency mining system using a solar panel according to another embodiment of the present disclosure.

FIG. 5 is a block diagram of a cryptocurrency mining system using a solar panel according to another embodiment of the present disclosure.

FIG. 6 is a block diagram of a cryptocurrency mining system for vehicles according to another embodiment of the present disclosure.

FIG. 7 is a step-by-step flowchart of a control method for a control device of a cryptocurrency mining system for vehicles according to one embodiment of the present disclosure.

FIG. 8 is a step-by-step flowchart of a control method for a control device of a cryptocurrency mining system for vehicles according to another embodiment of the present disclosure.

FIG. 9 is a step-by-step flowchart of a control method for an inverter of a cryptocurrency mining system for vehicles according to one embodiment of the present disclosure.

### BEST MODE

Hereinafter, the present disclosure will be described in detail by explaining exemplary embodiments of the present disclosure with reference to the attached drawings. The same reference numerals in the drawings denote like elements, and a redundant description thereof will be skipped. As used herein, the suffixes “unit” and “part” are added or used interchangeably to facilitate preparation of this specification and are not intended to suggest distinct meanings or functions. In the following description of the embodiments of the present disclosure, a detailed description of known technology will be omitted to avoid obscuring the subject matter of the present disclosure. The accompanying drawings are intended to facilitate understanding of the embodiments disclosed herein, and should not be construed as including all modifications, equivalents and substitutes included within the spirit and scope of the present disclosure.

It will be understood that, although the terms “first,” “second,” “third,” etc. may be used herein to describe various elements, the elements should not be limited by these terms.

These terms are only used to distinguish one element from another element.

It will be understood that when an element is referred to as being “on”, “connected to” or “coupled to” another element, it may be directly on, connected or coupled to the other element, or intervening elements may be present. In contrast, when an element is referred to as being “directly on,” “directly connected to” or “directly coupled to” another element or layer, there are no intervening elements present.

A singular expression includes a plural expression unless the context clearly dictates otherwise.

In this specification, the term “include” or “have” is intended to indicate that characteristics, figures, steps, operations, constituents, and components disclosed in the specification or combinations thereof exist. The term “include” or “have” should be understood as not pre-excluding possibility of existence or addition of one or more other characteristics, figures, steps, operations, constituents, components, or combinations thereof.

### First Embodiment

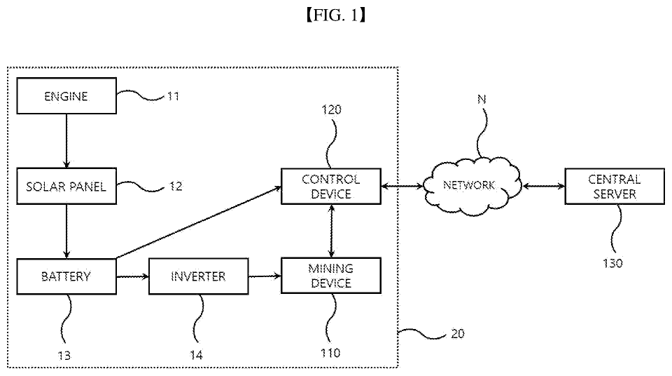

FIG. 1 is a block diagram of a cryptocurrency mining system using a solar panel according to one embodiment of the present disclosure.

As shown in FIG. 1, a cryptocurrency mining system using a solar panel according to one embodiment of the present disclosure may include a solar panel 12 configured to generate electric power using sunlight, a battery 13 configured to store the electric power generated by the solar panel 12, an inverter 14 connected to the solar panel 12 and/or the battery 13 to convert direct current power into alternating current power, a mining device 110 configured to mine cryptocurrency using the converted power output from the inverter 14, and a control device 120 configured to monitor a mining status of the mining device 110.

Here, the mining device 110 and the control device 120, as well as the solar panel 12, the battery 13, and the inverter 14, may be provided in a house 10.

The house 10 is an inhabited structure. In the present disclosure, the house refers to any type of structure, without limitation.

The mining device 110 according to one embodiment of the present disclosure is a device capable of performing a computational function to mine cryptocurrency, and may be a computing device including at least one graphics card or hashboard.

In order for the mining device 110 to perform the computational function to solve complex mathematical or cryptographic problems, it needs to be supplied with external power, and the driving power of the mining device 110 may be generated by the solar panel 12 installed on the house 10. Preferably, the driving power of the mining device 110 may be the electric power generated by the solar panel 12 and stored in the battery 13.

The solar panel 12 installed on the house 10 may absorb solar energy and convert the same into electrical energy to generate direct current power. At least a part of the generated power may be stored in the battery 13. Accordingly, the mining device 110 may be supplied with power generated directly by the solar panel 12 or with power pre-stored in the battery 13. Thus, the mining device 110 may perform cryptocurrency mining.

Generally, the power output from the solar panel 12 or the battery 13 is direct current power. Therefore, the inverter 14 may be further included to convert this power into sinusoidal alternating current power and provide the alternating current power to the mining device 110. This is because the power supplied to the power supply (e.g., switched mode power supply (SMPS)) of the mining device 110 is usually alternating current power.

The mining device 110 may be generally provided in the house 10, and the cryptocurrency mined by the mining device 110 may be delivered to the central server 130 connected to the external Internet. That is, the cryptocurrency mined by the mining device 110 provided in the house 10 may be transmitted to a central server 130 communicably connected to the mining device, and the central server 130 may store the received cryptocurrency in an electronic wallet of the resident of the house.

As described above, the mining device 110 may be driven to perform the mining operation and transmit the mined cryptocurrency to the central server 130, and the central server 130 may store the cryptocurrency in the electronic wallet of the resident of the house. Accordingly, the mining device 110 may perform a user authentication procedure with the house resident and may mine cryptocurrency only when the user authentication is successful.

Thereby, the cryptocurrency mined by the mining device 110 may be prevented from being misdirected to someone other than the resident of the house.

The mining device 110 may perform the user authentication procedure directly with the house resident. In a preferred embodiment, the control device 120 may perform the user authentication procedure with the house resident and communicate the result thereof to the mining device 110.

The cryptocurrency mining system using a solar panel according to one embodiment of the present disclosure may further include a control device 120 communicably connected to the mining device 110.

The control device 120 is configured to control the status of the mining device 110, and may include a display to provide status information about the mining device 110 to a resident of the house.

In other words, the control device 120 may receive, upon request, the current mining status of the mining device 110 and output the same on the display.

Additionally, the mining device 110 may not be directly communicably connected to the central server 130, but may be communicably connected to the central server 130 via the control device 120. In this case, the control device 120 may receive, upon request, the status of the electronic wallet of the resident of the house in the central server 130 and display the same on the display.

Using the control device 120, the resident of the house may check the current mining status of the mining device 110 or the status of the electronic wallet of the resident of the house in the central server 130 on the display in real time.

In addition, the control device 120 may receive user input by touch input, button input, or the like. Also, as described above, the control device 120 may perform a user authentication procedure with the resident of the house through the user input.

According to one embodiment of the present disclosure, based on the user input, the control device 120 may make a request for currency exchange or make a payment request for a predetermined transaction using a pre-mined cryptocurrency to the central server 130.

In other words, based on the user input through the control device 120, the central server 130 may make a request for exchange of the cryptocurrency mined by the mining device 110 into another type of cryptocurrency or cash. According to the exchange request, the central server 130 may exchange the cryptocurrency into another type of cryptocurrency and store the other type of cryptocurrency in the electronic wallet, or exchange the cryptocurrency into cash and store the cash in a bank account or the like by linking with a transaction server where cryptocurrency is traded.

In addition, the control device 120 may make a request for payment for a predetermined price of a transaction to the central server 130 to which it is communicably connected.

When the control device 120 or a terminal connected thereto performs a transaction for goods, services, or the like, it may make a request for a payment to the central server 130 to settle the price incurred by the transaction. Upon receiving the payment request, the central server 130 may perform the payment by means of some type of cryptocurrency stored in the electronic wallet and/or cash.

Here, the transaction is not particularly limited, but may be, for example, an electricity bill for the house 10 in which the mining device 110 is provided, or a charge for charging an electric vehicle externally when a vehicle 20, which will be described later, is an electric vehicle.

The mining device 110 of the cryptocurrency mining system using a solar panel according to one embodiment of the present disclosure is provided in a house to perform cryptocurrency mining, but a large amount of heat may be generated as the mining device 110 performs many computations.

Therefore, the mining device 110 may further include at least one fan configured to exhaust the heat generated by the mining device 110 to the outside of the mining device 110 or to the outside of the house 10, and a duct (not shown) arranged to guide the heat to the outside by the fan.

In other words, a large amount of heat generated by the mining apparatus 110 may be forced to be exhausted to the outside through the duct by the operation of the fan.

In addition, since the house 10 generally includes an air conditioner (not shown) having a cooling cycle to regulate the indoor air conditioning environment, in particular to cool the interior of the house 10, the cold air generated by the air conditioner may be provided to the mining device 110. Thus, the large amount of heat generated by the mining device 110 may be cooled more effectively by the cold air generated by the air conditioner.

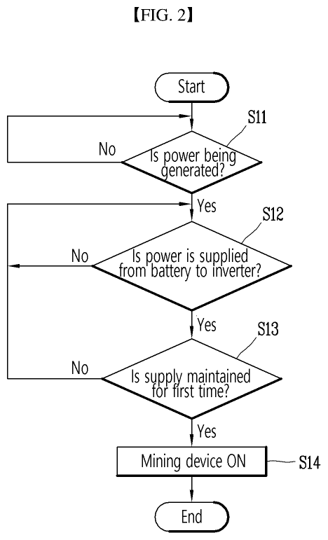

FIG. 2 is a step-by-step flowchart of a control method for a control device of a cryptocurrency mining system using a solar panel according to one embodiment of the present disclosure.

As shown in FIG. 2, the control device 120 according to one embodiment of the present disclosure may determine whether the solar panel 12 is generating electric power (S11) and may determine, when the solar panel 12 is generating electric power, whether power is supplied from the battery 13 to the inverter 14 (S12).

In this regard, the control device 120 may determine whether the solar panel 12 is generating electric power based on whether a value measured using an ammeter or a voltmeter provided at the rear end of the solar panel 12. However, the present disclosure is not particularly limited thereto.

The control device 120 may detect whether a direct current or voltage is supplied to the receiving end of the inverter 14 using the ammeter, the voltmeter, or the like. In this case, the control device 120 may determine whether power is continuously supplied from the battery 13 to the inverter 14 for a first time (S13). Only when power is supplied continuously from the battery 13 to the inverter 14 for the first time, the control device 120 may turn on the mining device 110 (S14).

Here, the first time is a time for checking whether the solar panel 12 can operate normally and continuously produce and supply power. The time is not particularly limited, but may be, for example, one minute.

Since the solar panel 12 is a means of generating power by converting light energy into electrical energy, and is responsive to sunlight, it cannot generate power when there is a lot of cloud cover. Therefore, the control device 120 may check if power is continuously supplied at the receiving end of the inverter 14 for the first time. When the power supply is maintained for the first time, the control device 120 may turn on the mining device 110 because a continuous power supply is expected from then on.

On the other hand, when the control device 120 determines that the power supply to the receiving end of the inverter 14 is not maintained for the first time, the control device 120 may not turn on the mining device 110 because, due to the unstable power supply, the mining device 110 may shut down unexpectedly, which may cause a failure of the mining device 110.

As described above, the control device 120 may turn on/off the mining device 110. In this case, the control device 120 may control the power on/off of the mining device 110 based on the remaining power of the battery 13.

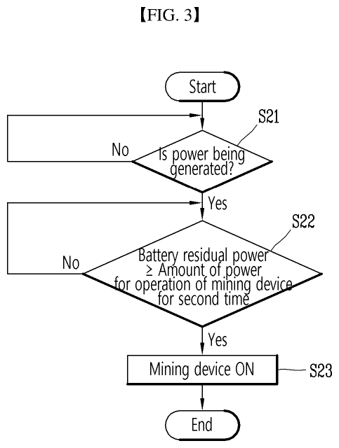

FIG. 3 is a step-by-step flowchart of a control method for a control device of a cryptocurrency mining system for vehicles according to another embodiment of the present disclosure.

As shown in FIG. 3, the control device 120 according to one embodiment of the present disclosure may determine whether the solar panel 12 is generating electric power (S21). When the solar panel 12 is generating electric power, the control device 120 may determine whether the amount of residual power stored in the battery 13 is enough to allow the mining device 110 to operate for at least a second time (S22).

In other words, the control device 120 may monitor the remaining power of the battery 13. In this operation, the control device 120 may check whether the amount of residual power in the battery 13 is greater than or equal to the amount of power for operation of the mining device 110 for the second time.

Here, the second time may be the sum of the boot time and the shutdown time of the mining device 110. In other words, the mining device 110 reads the operating system and programs at the time of booting such that the mining device 110 can perform the mining operation. If power is not supplied normally to the mining device 110 due to insufficient power stored in the battery 13 during the booting of the mining device 110, the mining device 110 may have a problem that a subsequent reboot may not be performed normally. On the other hand, if the mining device 110 fails to receive normal power from the battery 13 during the shutdown of the mining device 110, the operating system and programs that are running at the time of shutdown may not be terminated normally, and subsequent mining operations may not be performed smoothly.

Accordingly, the control device 120 preferably checks whether the amount of residual power in the battery 13 is greater than or equal to the amount of power that allows the mining device 110 to operate for the second time, and may then turn on the mining device 110 if the amount of residual power in the battery 13 is sufficient.

When the solar panel 12 is generating electric power, the amount of residual power in the battery 13 may be sufficient if it allows the mining device 110 to operate for a boot time. However, the second time is preferably the sum of the boot time and the shutdown time of the mining device 110, as described above.

On cloudy days, clouds may block sunlight from time to time, causing the solar panel 12 to not generate power. Therefore, in order to prevent the mining device 110 from shutting down unexpectedly when the solar panel 12 stops generating power due to the blockage of sunlight, the amount of power remaining in the battery 13 for turning on the mining device 110 is preferably greater than the sum of the amount of power required during the boot time of the mining device 110 and the amount of power required during the shutdown time of the mining device 110.

According to another embodiment of the present disclosure, the mining device 110, rather than the control device 120, may monitor the amount of the residual power in the battery 13.

The control device 120 may determine whether the solar panel 12 is currently generating power (S21), and then generate a control instruction to turn on the mining device 110 if the solar panel 12 is currently generating power. Alternatively, the mining device 110 may not immediately turn on power in response to the control instruction. Instead, the mining device 110 may check whether the amount of residual power in the battery 13 is greater than or equal to than the amount of power that allows the mining device 110 to operate for the second time, and may then turn on the mining device 110 only if the amount of residual power in the battery 13 is sufficient.

Of course, if the amount of residual power in the battery 13 is insufficient, the mining device 110 may not turn on the mining device 110 and may notify the control device 120 that the mining device 110 cannot be turned on.

The inverter 14 is a device configured to convert the direct current power supplied by the battery 13 into the alternating current power required by the mining device 110 to supply power to the mining device 110 in a constant and smooth manner. The inverter 14 according to one embodiment of the present disclosure may generate and transmit a control instruction to the mining device 110 to turn off the mining device 110 when the solar panel 12 stops generating power.

In other words, as described above, the control device 120 may control the ON/OFF of the mining device 110, but the inverter 14 according to one embodiment of the present disclosure may generate a control instruction to turn off the mining device 110.

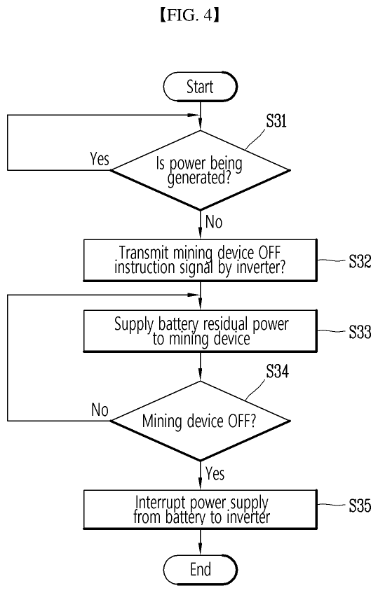

FIG. 4 is a step-by-step flowchart of a control method for an inverter of a cryptocurrency mining system for vehicles according to one embodiment of the present disclosure.

As shown in FIG. 4, the inverter 14 may determine whether the solar panel 12 according to one embodiment of the present disclosure is generating power (S31). When the solar panel 12 is not generating power, the inverter 14 may generate and transmit a control instruction to turn off the mining device 110 (S32).

When the solar panel 12 stops generating power, the inverter 14 may transmit the control instruction to turn off the mining device 110 (S32) such that the mining device 110 may perform the shutdown procedure normally, and may then supply the residual power in the battery 13 to the mining device 110 (S33) until the mining device 110 completes the shutdown procedure and turns off (S34). Accordingly, the residual power stored in the battery 13 is preferably supplied to the mining device 110 to allow the mining device 110 to operate smoothly during the shutdown time.

Thereafter, the inverter 14 may cut off the power supplied from the battery 13 (S35), thereby preventing unnecessary consumption of power stored in the battery 13.

As described above, the central server 130 may control the mining device 110 directly or indirectly through the control device 120. In particular, the mining device 110 may notify the central server 130 of an abnormality or failure.

In this regard, the mining device 110 may perform self-diagnosis in the event of an abnormality or failure and deliver the diagnosis results to the central server 130, and the central server 130 may control, modify, or reinstall the program through remote control of the mining device 110. The central server 130 may remotely turn on, turn off, or reboot the mining device 110.

The cryptocurrency or the like mined by the mining device 110 may be distributed to the operator of the central server 130 and the resident of the house in a predetermined ratio.

According to a preferred embodiment, when the central server 130 stores the mined cryptocurrency in the electronic wallet of the resident of the house, it may be distributed to the operator operating the central server 130 and the resident of the house in a predetermined ratio. For example, when 10 cryptocurrencies are mined, they may be divided into the operator and the resident of the house in a ratio of 3:7. That is, 3 and 7 cryptocurrencies may be distributed to the two parties, respectively.

This is because, as described below, the operator can perform maintenance and repair to ensure that the mining device 110 may smoothly perform mining in the event of an abnormality of the mining device 110. Furthermore, if the mining operation is stopped due to an abnormality of the mining device 110, the operator can also compensate for the downtime. Therefore, it is beneficial to both the operator and the driver to share a percentage of the revenue.

Since the mining device 110 may stop mining when an abnormality occurs and while it is being repaired, the central server 130 according to one embodiment of the present disclosure may compensate the resident of the house for the downtime during which the resident of the house cannot mine cryptocurrency even though power is being generated by the solar panel 12.

However, the compensation provided by the central server 130 to the resident of the house may be a cryptocurrency to be mined. The compensation may be less than or equal to the expected cryptocurrency profit that the resident of the house can earn from generating electricity using the solar panel 12. Preferably, the compensation may be equal to the expected cryptocurrency profit multiplied by a compensation factor of less than 1 (e.g., 0.1) to avoid the problem of maliciously causing the mining device 110 to fail.

Furthermore, since the central server 130 performs the compensation in the event that the resident of the house fails to perform the mining operation even though the solar panel 12 is generating electric power, the central server 130 must be able to check whether the solar panel 12 is generating electric power even though there is an abnormality in the mining device 110.

To this end, the central server 130 may receive, from the control device 120 rather than from the mining device 110, information about whether the solar panel 12 is generating electric power regardless of whether the mining device 110 has failed.

As a result, the central server 130 may compensate the driver of the vehicle for the downtime during which the solar panel 12 is generating electric power but the mining device 110 cannot mine due to a failure of the mining device 110, as much as a value obtained by multiplying the expected cryptocurrency profit by the compensation factor.

### Second Embodiment

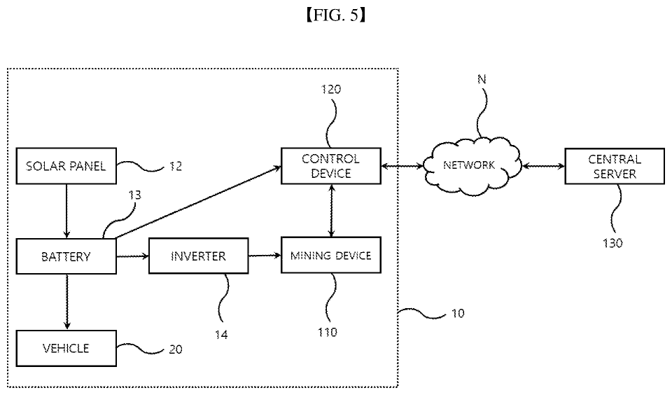

In accordance with yet another embodiment of the present disclosure, a vehicle 20 parked in the house 10 may be charged by power directly generated and supplied from the solar panel 12, or by power pre-stored in the battery 13 as shown in FIG. 5.

The vehicle 20 may be, but is not limited to, an electric vehicle. In a preferred embodiment, the vehicle 20 may include a cryptocurrency mining system.

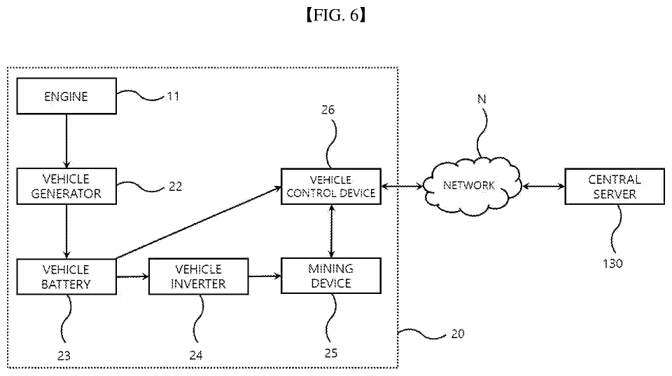

FIG. 6 is a block diagram of a cryptocurrency mining system for vehicles according to another embodiment of the present disclosure.

As shown in FIG. 6, the vehicle 20 according to one embodiment of the present disclosure may include a vehicle generator 22 configured to generate electric power by driving the engine 21, a vehicle battery 23 configured to store the electric power generated by the vehicle generator 22, a vehicle inverter 24 connected to the vehicle generator 22 or the vehicle battery 23, the vehicle inverter 24 being configured to convert direct current power into alternating current power, a vehicle mining device 25 configured to mine cryptocurrency using the converted power output from the vehicle inverter 14, and a vehicle control device 26 to monitor a mining status of the vehicle mining device 25.

Here, the engine 21, the vehicle generator 22, the vehicle battery 23, the vehicle inverter 24, the vehicle mining device 25, and the vehicle control device 26 may be mounted on the vehicle 20.

The vehicle 20 may be moved by driving a motor (not shown) or the engine 21. The present disclosure does not specifically limit the type of the vehicle 20.

The vehicle mining device 25 according to one embodiment of the present disclosure is a device capable of performing a computational function to mine cryptocurrency, similar to the mining device 110 in the house 10. It may be a computing device including at least one graphics card or hashboard.

In order for the vehicle mining device 25 to perform the computational function to solve complex mathematical or cryptographic problems, it must be powered externally, and the driving power for the vehicle mining device 25 may be generated by driving the engine 21 in the vehicle 20.

The vehicle generator 22 in the movable vehicle 20 may generate electric power by driving the engine 21, and at least a part of the power generated by the vehicle generator 22 may be stored in the vehicle battery 23. The vehicle mining device 25 may be supplied with power generated directly by the vehicle generator 22, or with power pre-stored in the vehicle battery 23 to perform the mining operation to mine cryptocurrency.

Alternatively, the vehicle battery 23 may store electric energy generated by the solar panel 12 in the house 10 and supplied directly or indirectly, and the vehicle mining device 25 may be supplied with power pre-stored in the battery 13 in the house 10, or with power pre-stored in the vehicle battery 23 to perform the mining operation to mine cryptocurrency.

Since the power output from the vehicle generator 22 or the vehicle battery 23 is typically direct current power of 12 V or 24 V, the vehicle inverter 24 may be further included to convert the power into sinusoidal alternating current power and provide the alternating current power to the vehicle mining device 25. This is because the power supplied to the power supply (e.g., switched mode power supply (SMPS)) of the vehicle mining device 25 is typically alternating current power.

As a result, the vehicle mining device 25 may mine cryptocurrency using the power generated by the movement of the vehicle 20 or by the operation of the engine 21. When the vehicle 20 is parked in the house 10, the vehicle mining device 25 may mine cryptocurrency using the power generated by the solar panel 12 in the house 10 and directly or indirectly supplied thereto.

Since the vehicle mining device 25 is provided in the movable vehicle 20, it may be subject to continuous impact from the outside. Thus, the impact from the outside may unintentionally cause the vehicle mining device 25 to malfunction or unintentionally cause the vehicle mining device 25 to stop working.

Therefore, according to one embodiment of the present disclosure, the vehicle mining device 25 is preferably mounted in an enclosure made of a shock-absorbing material, such as urethane or sponge, and is provided in the vehicle 20.

According to a specific embodiment, the vehicle mining device 25 may be provided in the trunk of the vehicle 20. In the case where the vehicle inverter 24 is provided in the engine compartment, the vehicle inverter 24 in the engine compartment and the vehicle mining device 25 in the trunk may be connected to each other by a power line.

In addition, the cryptocurrency mined by the vehicle mining device 25 may be transferred to the central server 130 connected to the external Internet. In other words, the cryptocurrency mined by the vehicle mining device 25 in the vehicle 20 may be transferred to the central server 130 communicably connected to the vehicle mining device 25, and the central server 130 may store the transferred cryptocurrency in a pre-configured electronic wallet of the vehicle driver.

According to a preferred embodiment, when the central server 130 stores the mined cryptocurrency in the electronic wallet of the vehicle driver, it may be distributed to the operator operating the central server 130 and the vehicle driver in a predetermined ratio. For example, when 10 cryptocurrencies are mined, they may be divided into the operator and the vehicle driver in a ratio of 3:7. That is, 3 and 7 cryptocurrencies may be distributed to the two parties, respectively. However, the present disclosure is not limited thereto.

This is because, as described below, the operator can perform maintenance and repair to ensure that the vehicle mining device 25 may smoothly perform mining in the event of an abnormality of the vehicle mining device 25. Furthermore, if the mining operation is stopped due to an abnormality of the vehicle mining device 25, the operator can also compensate for the downtime. Therefore, it is beneficial to both the operator and the driver to share a percentage of the revenue.

Here, when the central server 130 stores the cryptocurrencies mined by the vehicle mining device 25 in the electronic wallet of the vehicle driver, the cryptocurrencies may be distributed to the operator operating the central server 130, the vehicle driver, and the resident of the house 10 that supplies power generated by the solar panel 12 in a predetermined ratio. In this case, a proportion of the cryptocurrencies corresponding to the amount of electric power supplied to the vehicle 20 by the solar panel 12 may be stored in the electronic wallet of the resident of the house.

The central server 130 according to one embodiment of the present disclosure may directly distribute the mined cryptocurrencies to the operator and the vehicle driver, or to the operator, the vehicle driver, and the resident in a predetermined ratio. However, the present disclosure is not limited thereto. Cash exchanged for the mined cryptocurrency through a cryptocurrency exchange (or cryptocurrency exchange server), or fees incurred when converting the mined cryptocurrency into another currency (such as another cryptocurrency or cash) through a cryptocurrency exchange (or cryptocurrency exchange server), may be distributed between the operator and the vehicle driver, or between the operator, the vehicle driver, and the resident of the house in a predetermined ratio.

In addition, since the vehicle mining device 25 performs the mining operation when the vehicle 20 is operated and transfers the mined cryptocurrency to the central server 130, and the central server 130 stores the cryptocurrency in the electronic wallet of the vehicle driver, the vehicle mining device 25 may perform a user authentication procedure with the vehicle driver and may mine cryptocurrency only when the user authentication is successful.

By identifying the vehicle driver who operates the vehicle through the user authentication process, the cryptocurrency mined by the vehicle mining device 25 may be prevented from being misdirected to someone other than the vehicle driver.

The vehicle mining device 25 may directly perform the user authentication procedure with the vehicle driver. However, since the vehicle mining device 25 is mounted in an enclosure formed of a shock-absorbing material as described above, the vehicle control device 26 provided in the interior of the vehicle 20 may perform the user authentication procedure with the vehicle driver and transmit the result to the vehicle mining device 25.

Accordingly, the vehicle cryptocurrency mining system according to one embodiment of the present disclosure may further include the vehicle control device 26 communicably connected to the vehicle mining device 25. Here, the vehicle control device 26 is a device configured to control the status of the vehicle mining device 25, and may include a display configured to provide the status information about the vehicle mining device 25 to the vehicle driver.

In other words, the vehicle control device 26 may receive the current mining status of the vehicle mining device 25 upon request and output the same through the display.

Also, the vehicle mining device 25 may not be directly communicably connected to the central server 130, but may be communicably connected to the central server 130 via the vehicle control device 26. In this case, the vehicle control device 26 may receive, upon request, the status of the electronic wallet of the vehicle driver in the central server 130 and output the same through the display.

Using the vehicle control device 26, the vehicle driver may check the current mining status of the vehicle mining device 25 or the status of the vehicle driver's electronic wallet in the central server 130 on the display in real time.

In addition, the vehicle control device 26 may receive user input by touch input, button input, or the like. Also, as described above, the vehicle control device 26 may perform a user authentication procedure with the vehicle driver through the user input.

The vehicle control device 26 may control the status of the vehicle mining device 25 as described above, and may also control the power to the vehicle mining device 25 to be turned on/off.

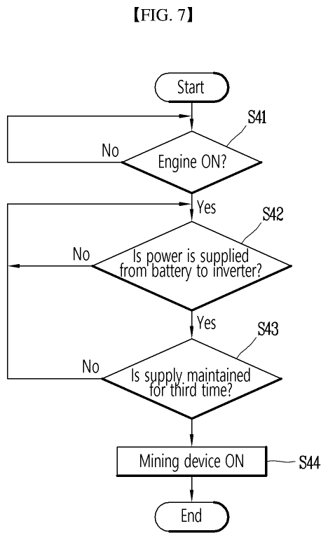

FIG. 7 is a step-by-step flowchart of a control method for a control device of a cryptocurrency mining system for vehicles according to one embodiment of the present disclosure.

As shown in FIG. 7, the vehicle control device 26 according to one embodiment of the present disclosure may determine whether the engine 21 is running in the ON state (S41) and may determine whether power is supplied from the vehicle battery 23 to the vehicle inverter 24 if the engine is running in the ON state (S42).

The vehicle control device 26 may detect whether a direct current or voltage is supplied to the receiving end of the vehicle inverter 24 using the ammeter, the voltmeter, or the like. In this case, the vehicle control device 26 may determine whether power is continuously supplied from the vehicle battery 23 to the vehicle inverter 24 for a third time (S43). Only when power is supplied continuously from the vehicle battery 23 to the vehicle inverter 24 for the third time, the vehicle control device 26 may turn on the vehicle mining device 25 (S44).

Here, the third time is a time for checking whether the engine 21 or the vehicle generator 22 can operate normally and continuously produce and supply power. The time is not particularly limited, but may be, for example, one minute.

Therefore, the vehicle control device 26 may check if power is continuously supplied at the receiving end of the vehicle inverter 24 for the third time. When the power supply is maintained for the third time, the vehicle control device 26 may turn on the vehicle mining device 25 because a continuous power supply is expected from then on.

On the other hand, when the vehicle control device 26 determines that the power supply to the receiving end of the vehicle inverter 24 is not maintained for the third time, the vehicle control device 26 may not turn on the vehicle mining device 25 because, due to the unstable power supply, the vehicle mining device 25 may shut down unexpectedly, which may cause a failure of the vehicle mining device 25.

As described above, the vehicle control device 26 may turn on/off the vehicle mining device 25. In this case, the vehicle control device 26 may control the power on/off of the vehicle mining device 25 based on the remaining power of the vehicle battery 23.

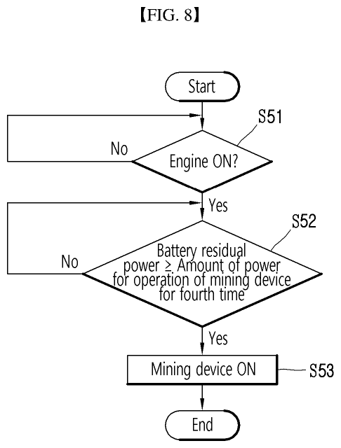

FIG. 8 is a step-by-step flowchart of a control method for a control device of a cryptocurrency mining system for vehicles according to another embodiment of the present disclosure.

As shown in FIG. 8, the vehicle control device 26 according to one embodiment of the present disclosure may determine whether the engine 21 is running in the ON state (S51). When the engine 21 is in the ON state, the vehicle control device 26 may determine whether the amount of residual power stored in the vehicle battery 23 is enough to allow the vehicle mining device 25 to operate for at least a fourth time (S52).

In other words, the vehicle control device 26 may monitor the remaining power of the vehicle battery 23. In this operation, the vehicle control device 26 may check whether the amount of residual power in the vehicle battery 23 is greater than or equal to the amount of power for operation of the vehicle mining device 25 for the fourth time.

Here, the fourth time may be the sum of the boot time and the shutdown time of the vehicle mining device 25. In other words, the vehicle mining device 25 reads the operating system and programs at the time of booting such that the vehicle mining device 25 can perform the mining operation. If power is not supplied normally to the vehicle mining device 25 due to insufficient power stored in the vehicle battery 23 during the booting of the vehicle mining device 25, the vehicle mining device 25 may have a problem that a subsequent reboot may not be performed normally. On the other hand, if the vehicle mining device 25 fails to receive normal power from the vehicle battery 23 during the shutdown of the vehicle mining device 25, the operating system and programs that are running at the time of shutdown may not be terminated normally, and subsequent mining operations may not be performed smoothly.

Accordingly, the vehicle control device 26 preferably checks whether the amount of residual power in the vehicle battery 23 is greater than or equal to the amount of power that allows the vehicle mining device 25 to operate for the fourth time, and may then turn on the vehicle mining device 25 if the amount of residual power in the vehicle battery 23 is sufficient.

When the vehicle 20 is started, the amount of residual power in the vehicle battery 23 may be sufficient if it allows the vehicle mining device 25 to operate for a boot time. However, the fourth time is preferably the sum of the boot time and the shutdown time of the vehicle mining device 25, as described above.

This is because the recently released vehicle 20 may be equipped with an ISG (Idle Stop&Go) function, and thus the engine 21 may be turned off while the vehicle 20 is stopped. Accordingly, in order to prevent the vehicle mining device 25 from unexpectedly shutting down when the operation of the engine 21 is stopped by the ISG function, the amount of residual power n the vehicle battery 23 for turning on the vehicle mining device 25 preferably exceeds the sum of the amount of power required during the boot time of the vehicle mining device 25 and the amount of power required during the shutdown time of the vehicle mining device 25.

According to another embodiment of the present disclosure, the vehicle mining device 25, rather than the vehicle control device 26, may monitor the amount of the residual power in the vehicle battery 23.

The vehicle control device 26 may determine whether the engine 21 is running in the ON state (S51), and then generate a control instruction to turn on the vehicle mining unit 25 if the engine 21 in the ON state. Alternatively, the vehicle mining device 25 may not immediately turn on power in response to the control instruction. Instead, the vehicle mining device 25 may check whether the amount of residual power in the vehicle battery 23 is greater than or equal to than the amount of power that allows the vehicle mining device 25 to operate for the fourth time, and may then turn on the vehicle mining device 25 only if the amount of residual power in the vehicle battery 23 is sufficient.

Of course, if the amount of residual power in the vehicle battery 23 is insufficient, the vehicle mining device 25 may not turn on the vehicle mining device 25 and may notify the vehicle control device 26 that the vehicle mining device 25 cannot be turned on.

The vehicle inverter 24 is a device configured to convert the direct current power supplied by the vehicle battery 23 into the alternating current power required by the vehicle mining device 25 to supply power to the vehicle mining device 25 in a constant and smooth manner. The vehicle inverter 24 according to one embodiment of the present disclosure may generate and transmit a control instruction to the vehicle mining device 25 to turn off the vehicle mining device 25 when the engine 21 stops operating.

In other words, as described above, the vehicle control device 26 may control the ON/OFF of the vehicle mining device 25, but the vehicle inverter 24 according to one embodiment of the present disclosure may generate a control instruction to turn off the vehicle mining device 25.

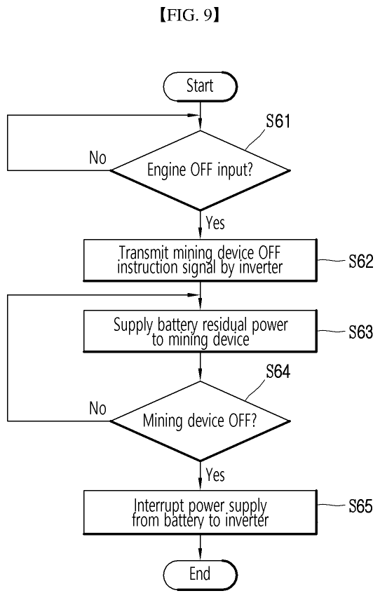

FIG. 9 is a step-by-step flowchart of a control method for an inverter of a cryptocurrency mining system for vehicles according to one embodiment of the present disclosure.

As shown in FIG. 9, it may be determined whether the vehicle 20 according to one embodiment of the present disclosure has a start ON input (S61). In the event that the vehicle 20 has a start OFF input, the vehicle inverter 24 may generate and transmit a control instruction to turn off the vehicle mining device 25 (S62).

When the operation of the engine 21 is stopped, the operation of the vehicle generator 22 is also stopped in turn. Thus, no more electric power is generated. At this time, the vehicle inverter 24 may transmit a power-off control instruction to the vehicle mining device 25 (S32) to allow the vehicle mining device 25 to perform the shutdown procedure normally, as described above. Then, the residual power in the vehicle battery 23 may be supplied to the vehicle mining device 25 (S63) until the vehicle mining device 25 completes the shutdown procedure and is turned off (S64). Accordingly, the residual power stored in the vehicle battery 23 is preferably supplied to the vehicle mining device 25 to allow the vehicle mining device 25 to operate smoothly during the shutdown time.

Thereafter, the vehicle inverter 24 may cut off the power supplied from the vehicle battery 23 (S65), thereby preventing unnecessary consumption of power stored in the vehicle battery 23.

Here, the vehicle control device 26 may generate and transmit a control instruction for turning off the vehicle mining device 25 in response to the OFF input for the engine 21, and the residual power in the vehicle battery 23 may be supplied to the vehicle mining device 25 until the vehicle mining device 25 is turned off. However, the vehicle control device 26 having the display means is usually powered off immediately in response to the OFF input for the engine 21. Accordingly, to cope with such vehicle 20, the vehicle inverter 24 according to one embodiment of the present disclosure preferably is allowed to control the OFF operation of the vehicle mining device 25 when the engine 21 is turned off.

As described above, the central server 130 may control the vehicle mining device 25 directly or indirectly through the vehicle control device 26. In particular, the vehicle mining device 25 may notify the central server 130 of an abnormality or failure.

In this regard, the vehicle mining device 25 may perform self-diagnosis in the event of an abnormality or failure and deliver the diagnosis results to the central server 130, and the central server 130 may control, modify, or reinstall the program through remote control of the vehicle mining device 25. The central server 130 may remotely turn on, turn off, or reboot the vehicle mining device 25.

As described above, the cryptocurrency or the like mined by the vehicle mining device 25 may be distributed to the operator of the central server 130 and the vehicle driver in a predetermined ratio.

Since the vehicle mining device 25 may stop mining when an abnormality occurs and while it is being repaired, the central server 130 according to one embodiment of the present disclosure may compensate the vehicle driver for the downtime during which the vehicle driver is unable to mine cryptocurrency even though the driver is driving the vehicle.

However, the compensation provided by the central server 130 to the vehicle driver may be a cryptocurrency to be mined. The compensation may be less than or equal to the expected cryptocurrency profit that the vehicle driver can earn from driving the vehicle. Preferably, the compensation may be equal to the expected cryptocurrency profit multiplied by a compensation factor of less than 1 (e.g., 0.1) to avoid the problem of maliciously causing the vehicle mining device 25 to fail.

Furthermore, since the central server 130 performs the compensation in the event that the vehicle driver fails to perform the mining operation even though the driver is driving the vehicle, the central server 130 must be able to check whether the vehicle 20 is being driven even though there is an abnormality in the vehicle mining device 25.

To this end, the central server 130 may receive, from the vehicle control device 26 rather than from the vehicle mining device 25, information about whether the vehicle 20 is being driven or the engine 21 of the vehicle 20 is in the ON state regardless of whether the vehicle mining device 25 has failed.

As a result, the central server 130 may compensate the driver of the vehicle for the downtime during which the vehicle 20 is being driven or the engine 21 of the vehicle 20 is in the ON state, but the vehicle mining device 25 cannot mine due to a failure of the vehicle mining device 25, as much as a value obtained by multiplying the expected cryptocurrency profit by the compensation factor.

The vehicle cryptocurrency mining system according to one embodiment of the present disclosure has the vehicle mining device 25 provided in a movable vehicle to mine cryptocurrency. In this operation, a large amount of heat may be generated as the vehicle mining device 25 performs many computations.

Therefore, the enclosure in which the vehicle mining device 25 according to one embodiment of the present disclosure is arranged may be provided with a fan (not shown). Thus, the heat inside the enclosure may be discharged to the outside by operating the fan.

However, the vehicle 20 in motion has a large amount of outside air introduced into the vehicle 20 by driving, and the outside air can be introduced at a high flow rate without a separate fan being provided. Accordingly, the vehicle cryptocurrency mining system according to one embodiment of the present disclosure may further include a duct to guide the outside air introduced from the outside into the vehicle mining device 25.

In other words, a large amount of heat generated by the vehicle mining device 25 may be cooled by air cooling by circulating with the large amount and/or high-speed outside air introduced through the duct.

In accordance with a further preferred embodiment, the duct may be provided with at least one filter (not shown) configured to filter out foreign substances contained in the outside air.

Furthermore, since the vehicle 20 generally includes an air conditioner (not shown) having a cooling cycle to regulate the indoor air conditioning environment, in particular to cool the interior of the vehicle, the cold air generated by the air conditioner may be injected into the duct and/or the duct itself may be cooled to provide the vehicle mining device 25 with the outside air introduced from the outside at a lower temperature.

Accordingly, a large amount of heat generated by the vehicle mining device 25 may be more effectively cooled by the cold air generated by the air conditioner.

### Third Embodiment

According to yet another embodiment of the present disclosure, a treadmill (not shown) provided in the house 10 may be charged with the electric power generated by the solar panel 12 and directly supplied thereto or power pre-stored in the battery 13.

In this case, the treadmill is an exercise machine used by a user to walk or run. When the user walks or runs on the belt, track, or endless track of the treadmill (hereinafter referred to as the “track”), power may be generated by the operation of the treadmill.

In other words, when the user walks or runs on the track corresponding to the engine 21 of the vehicle 20 in the preceding embodiment, power may be generated accordingly, and at least a portion of the generated power may be stored in a treadmill battery (not shown). Accordingly, a treadmill mining device (not shown) may be directly supplied with power generated from the rotating track, or may be supplied with power pre-stored in the treadmill battery to perform the mining operation of mining cryptocurrency.

The cryptocurrency mining system for a treadmill according to this embodiment may include a power generating part (not shown) configured to generate electric power by rotation of a track, a treadmill battery configured to store the power generated by the power generating part, a treadmill inverter connected to the treadmill battery to convert direct current power into alternating current, a treadmill mining device configured to mine cryptocurrency using the converted power output from the treadmill inverter, and a treadmill control device configured to monitor the mining status of the treadmill mining device.

Here, the power generating part, the treadmill battery, the treadmill inverter, the treadmill mining device, and the treadmill control device may be mounted on the treadmill.

The power generating part, the treadmill battery, the treadmill inverter, the treadmill mining device, and the treadmill control device correspond to the vehicle generator 22, the vehicle battery 23, the vehicle inverter 24, the vehicle mining device 25, and the vehicle control device 26 of the preceding embodiment, and thus a detailed description thereof will be omitted.

While present disclosure has been particularly shown and described with reference to exemplary embodiments thereof, it will be understood by those skilled in the art that various changes in form and details may be made herein without departing from the spirit and scope of the present disclosure as defined by the appended claims.

Accordingly, the scope of the present disclosure is to be defined by the claims below rather than the detailed description, and all changes or modifications derived from the meaning, scope, and equivalent concept of the claims are included in the scope of the present disclosure.

1. A cryptocurrency mining system using a solar panel, the system comprising:
a solar panel configured to generate electric power using sunlight;
a battery configured to store the electric power generated by the solar panel;
an inverter connected to a generator or the battery to convert direct current power into alternating current power;
a mining device configured to mine cryptocurrency using the converted power output from the inverter; and
a control device configured to monitor a mining status of the mining device.

2. The system of claim 1, further comprising:
a central server configured to receive the cryptocurrency mined by the mining device and store the same in an electronic wallet of a house resident.

3. The system of claim 2, wherein the control device is communicably connected to the central server to monitor a status of the electronic wallet of the house resident.

4. The system of claim 1, wherein the control device performs a user authentication procedure with the house resident,
wherein the mining device mines the cryptocurrency when the user authentication procedure of the control device is successful.

5. The system of claim 4, wherein, based on a user input, the control device makes a request for currency exchange to the central server or a request for a payment of a predetermined transaction using the mined cryptocurrency to the central server.

6. The system of claim 2, wherein the central server controls the mining device,
wherein, when the mining operation is stopped due to an abnormality of the mining device, the central server counts a duration of the stopping and compensates the house resident for the stop time.

7. The system of claim 6, wherein the central server provides a portion of the mined cryptocurrency, cash exchanged for the mined cryptocurrency, or fees incurred in converting the mined cryptocurrency into another currency to the house resident, and provides the remaining portion to an operator of the central server.

8. The system of claim 1, wherein the control device is configured to:
determine whether power is supplied to the inverter from the battery; and
turn on the mining device when the power supplied to the inverter is maintained for a first time.

9. The system of claim 1, wherein, when an amount of residual power stored in the battery is enough to allow the mining device to operate for at least a second time, the control device turns on the mining device,
wherein the second time is a boot time and a shutdown time of the mining device.

10. The system of claim 9, wherein, upon interruption of power generation from the solar panel, the inverter transmits a signal to turn off the mining device,
wherein the battery supplies the stored residual power to the mining device to allow the mining device to operate during the shutdown time.

11. The system of claim 1, further comprising:
a cryptocurrency mining system for a vehicle, comprising:
a vehicle mining device configured to mine cryptocurrency using the power generated by the solar panel and power generated by driving an engine of the vehicle.

12. The system of claim 1, further comprising:
a cryptocurrency mining system for a treadmill configured to mine cryptocurrency using the power generated by the solar panel and power generated by a track of the treadmill rotated by a user walking or running.
